(19) United States
(12) Patent Application Publication
(10) Pub. No.: US 2019/0084387 A1
(43) Pub. Date: Mar. 21, 2019

(54) INNER PANEL ASSEMBLY OF A VEHICLE DOOR

(71) Applicant: Ford Global Technologies LLC, Dearborn, MI (US)

(72) Inventors: Nathan Gregory Smith, Werribee South (AU); Dave Spink, Jan Juc (AU)

(21) Appl. No.: 16/020,858

(22) Filed: Jun. 27, 2018

(30) Foreign Application Priority Data
Sep. 19, 2017 (CN) 201710847915.X

(51) Int. Cl. B60J 5/04; B60J 10/74

(52) U.S. Cl. CPC B60J 5/0455; B60J 5/0481; B60J 10/74; B60J 5/0402; B60J 5/0483; B60J 5/0469

(57) ABSTRACT

An inner panel assembly of a side door of a vehicle comprises an inner panel including an inner panel portion and a reinforcement part. The inner panel portion includes a base, an outer edge and an inner edge along a length direction and partially defines a window aperture. The reinforcement part has a first end and a second end along the length direction, and is connected to the inner panel portion via a clinched herring process, and the first end and the second end of the reinforcement part are received in an outer clinched hem flange and an inner clinched hem flange of the inner panel portion formed by the outer edge and the inner edge during the clinched hem process, respectively.

### RELATED APPLICATION

This application claims the benefit of Chinese Patent Application No.: CN 201710847915.X filed on Sep. 19, 2017, the entire contents thereof being incorporated herein by reference.

### FIELD

The present disclosure relates to a vehicle side door, specifically relates to an inner panel assembly including a reinforcement part connected to the inner panel via clinch herring process.

### BACKGROUND OF THE INVENTION

In sonic vehicles, an inner panel of a side door includes a reinforcement part to reinforce an entire window aperture. The reinforcement part is one-piece metal made from stamping process. Due to the A-pillar shape and the large window cut out, material utilization of the reinforcement part is very low. Further, the reinforcement part is normally spot welded or laser welded to the inner panel with either spot welding or laser welding. For example, in a vehicle door 10 shown in FIGS. 7-8, a reinforcement part 12 is welded to a header inner panel portion 14 of an inner panel 16 at welded joints 18, 20 along a length direction of the header inner panel 14. As the inner panel 16 is made from metallic material such as steel or aluminum, the reinforcement part 12 is required to be similar metallic material for the welding. A garnish 11 is also attached for decoration purpose. The vehicle door 10 usually includes an applique 22 hooked and/or screwed to the reinforcement part 12. The applique 22 is a structural component as it is required to hold a glass pane 24 of a window in place and it also has a surface visible to customer, and thus the material used for the applique 22 is required to be both sufficiently strong and have good appearance. The inventors of the present application have recognized that the changes in both material and the structure building of the inner panel assembly of the vehicle door are needed to reduce an overall system cost and weight of the vehicle door.

### SUMMARY

According to one aspect, an inner panel assembly of a side door of a vehicle is provided. The inner panel assembly comprises an inner panel including an inner panel portion, a reinforcement part connected to the inner panel portion vis a clinch healing process. The inner panel portion includes a base, an outer edge and an inner edge along a length direction and at least partially defines a window aperture along a header portion and a pillar portion. The reinforcement part is disposed between the outer edge and the inner edge of the inner panel portion and having an outer end and an inner end along the length direction. The outer end and the inner end of the reinforcement part is received in an outer clinched hem flange and an inner clinched hem flange of the inner panel portion formed by the first outer edge and the inner edge of the inner panel portion during the clinched hem process, respectively.

In one embodiment, the reinforcement part may be made from plastic or polymer, the base of the inner panel portion is double bent, and the inner panel portion and the reinforcement part may form a closed loop at a cross section to provide required strength to support a glass pane in the window aperture.

In another embodiment, the inner panel portion may include a header inner panel portion and a pillar inner panel portion, and the reinforcement part includes a first reinforcement part corresponding to the header inner panel portion and a second reinforcement part corresponding to the pillar panel portion. The first reinforcement part may have a different configuration from the second reinforcement part, and the first and second reinforcement parts are integrally formed in an injection molding.

According to another aspect, a vehicle door comprises an inner panel including an inner panel portion, and a reinforcement part connected with the inner panel portion. The inner panel portion partially surrounds a window aperture, and includes an outer clinched hem flange along a length direction and an inner clinched hem flange opposing the first clinched hem flange. The reinforcement part is disposed between the outer clinched hem flange and the inner clinched hem flange along the length direction, and an outer end of the reinforcement part is received in the outer clinched hem flange and an inner edge of the reinforcement part is received in the inner clinched hem flange.

In one embodiment, the reinforcement part may be made of a polymer or a recycled polymer.

In another embodiment, the reinforcement part may be connected with the inner panel via a clinch heating process, and a cross-section of the inner panel portion includes a U-shape portion and forms a closed loop with the reinforcement part.

In another embodiment, the inner panel portion may be made of steel or aluminum or other modem materials such as laminated steel.

In another embodiment, the reinforcement part may include a plurality of ribs protruding toward an interior of the closed loop and contacting the inner panel portion,

In another embodiment, the reinforcement part and the ribs may be integrally formed in an injection molding.

In another embodiment, the inner panel assembly may further comprise a filler material between the inner panel and the reinforcement part.

According to yet another aspect, a vehicle door comprises an inner panel including a header inner panel portion and a pillar inner panel portion; a window aperture partially defined by the header inner panel portion, and the pillar inner panel portion; a glass run weather strip connected to the header inner panel portion and the pillar inner panel portion and configured to receive a glass pane; and a reinforcement part having an inner end and an outer end along the length direction. The header inner panel portion and the pillar e panel portion include an outer clinched hem flange and an inner clinched hem flange along a length direction. The inner end of the reinforcement part is connected to the inner clinched hem flange and the outer end of the reinforcement part is connected to the outer clinched hem flange via a clinched hem process.

In one embodiment, the reinforcement part may be made from plastic, a polymer, or glass or carbon filled derivatives.

In another embodiment, the header inner panel portion and the pillar inner panel portion may include a base having a U-shaped cross section, respectively and the header inner panel portion and the reinforcement part may form a first closed loop at the cross section and the pillar inner panel portion and the reinforcement part form a second closed loop at the cross section. The outer clinch hem flange and the inner clinch hem flange may be formed by clinch heming an outer edge of the header inner panel portion to the outer end of the reinforcement part and the inner clinched hem flange is formed by clinching the inner edge of the pillar inner panel portion to the inner end of the reinforcement part.

In another embodiment, the reinforcement part may include a first reinforcement part connected with the header inner panel portion. The first reinforcement part may have a flat portion and a curved portion, and the flat portion is substantially parallel the glass pane and includes the first inner end received in a first inner clinched hem flange, and the curved portion may include a first outer end received in first the outer clinched hem flange. The first outer clinched hem flange may be located at a top of the window aperture and connected with the glass run weather strip, and the first inner clinched hem flange may be disposed below the first outer clinched hem flange and spaced further away from the glass pane.

In another embodiment, the reinforcement part may further include a second reinforcement part connected with the pillar inner panel portion. The second reinforcement part may include a first portion adjacent to the window aperture and a second portion further away from the window aperture. The first portion may include a first outer end received in the outer clinched hem flange and the second portion may include an inner end received in the inner clinched hem flange. The inner clinched hem flange may be adjacent to the window aperture and connected with glass run weather strip, and the outer clinched hem flange may be disposed further away from the window aperture, and wherein the first and second reinforcement parts are integrally formed in an injection molding.

In another embodiment, the first portion may further include a first segment and a second segment connected to the second portion, wherein the second segment is disposed between the first segment and the second portion and have angle with first segment and the second portion, respectively.

In another embodiment, the reinforcement part may include a plurality of ribs protruding from a surface toward an interior of the closed loop, and the reinforcement part and the ribs may be formed integrally in an injection molding.

In another embodiment, the plurality of ribs may be disposed evenly along a length of the reinforcement part

In another embodiment, the plurality of ribs may be disposed in selected areas along a length of the reinforcement part.

In another embodiment, the vehicle door may further comprise an outer panel connected to the inner panel, and an applique connected to the glass run weather strip on the inner panel portion. The applique may conceal the glass run weather strip, the reinforcement part and the pillar inner panel portion.

The reinforcement part of the inner panel assembly of the present disclosure is connected to the inner panel portion via clinched hem process without welding. The elimination of the welding allows a wide choice of material for the reinforcement part for the inner panel. The plastic reinforcement part made from an injection molding can increase the material utilization. Further, the vehicle door of the present disclosure can achieve an overall reduction on the cost and the door weight due to the use of injection molded plastic and structural configuration of the inner panel and the reinforcement part.

### BRIEF DESCRIPTION OF THE DRAWINGS

Example embodiments will be more clearly understood from the following brief description taken in conjunction with the accompanying drawings. The accompanying drawings represent non-limiting, example embodiments as described herein.

FIG. 1 shows a perspective view of a side door of a vehicle according to one embodiment of the present disclosure.

FIG. 2A is a plan view of an inner panel in FIG. 1.

FIG. 2B shows an inner panel assembly in FIG. 1, illustrating a reinforcement part disposed on the inner panel.

FIG. 2C shows an inner panel assembly in FIG. 1, illustrating additional parts disposed on the inner panel.

FIG. 3 a perspective partial view of a side door in FIG. I.

FIG. 4 is a cross-sectional view of the side door in FIG. 1 along lines II-II.

FIG. 5 is a cross-sectional view of the side door in FIG. 1 along lines III-III.

FIG. 6 shows a reinforcement part according to one embodiment of the present disclosure.

FIG. 7 is a perspective partial view of a side door of a vehicle in prior art.

FIG. 8 is a cross-sectional view of a header portion of the side door in FIG. 7 along lines I-I, illustrating connections between an inner panel and a reinforcement part.

It should be noted that these figures are intended to illustrate the general characteristics of methods, structure and/or materials utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments. The use of similar or identical reference numbers in the various drawings is intended to indicate the presence of a similar or identical element or feature.

### DETAILED DESCRIPTION

The disclosed inner panel assemblies of a vehicle will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various inner panel assemblies are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

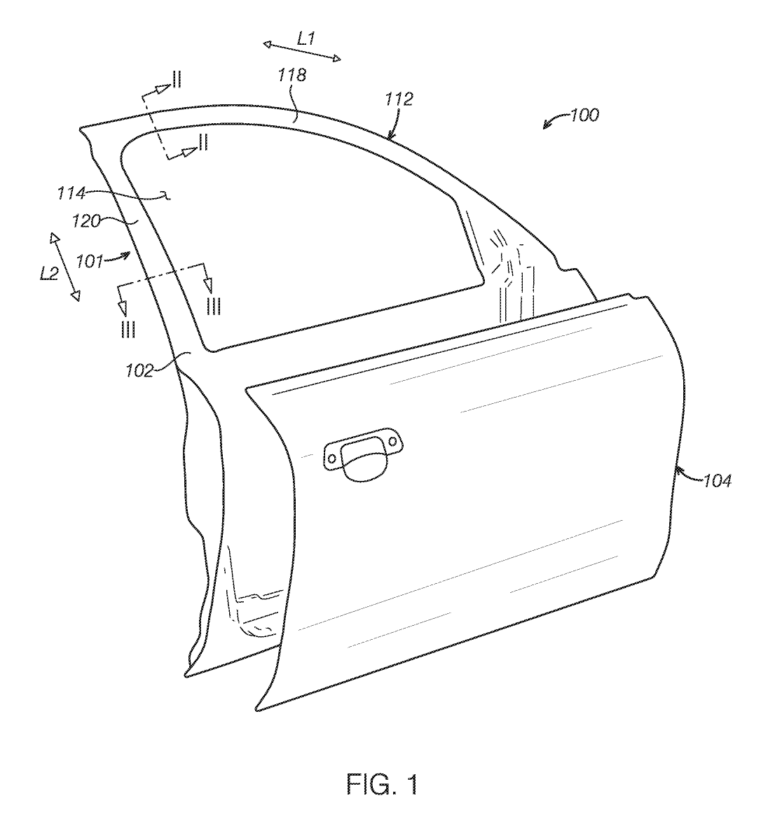

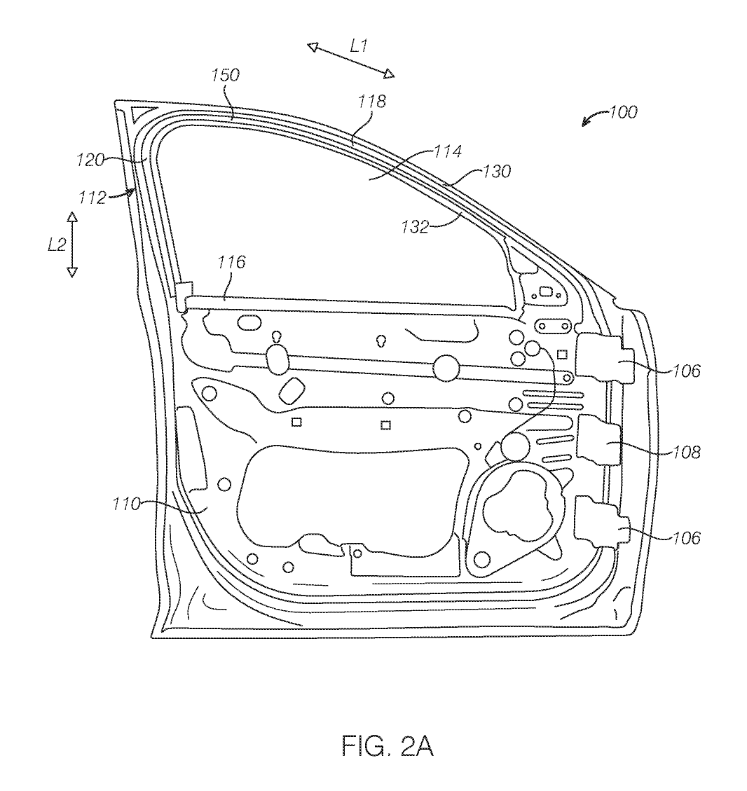

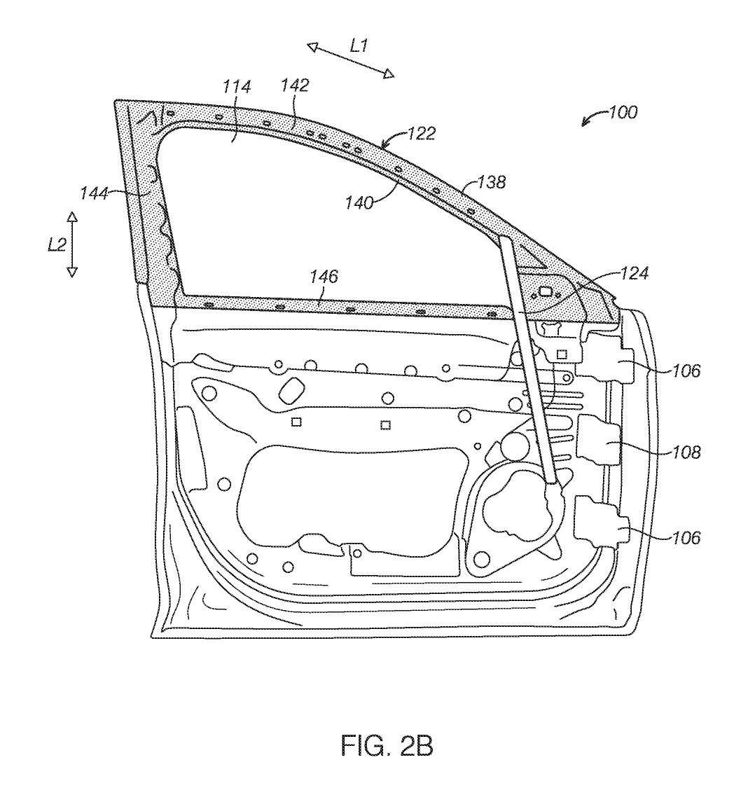

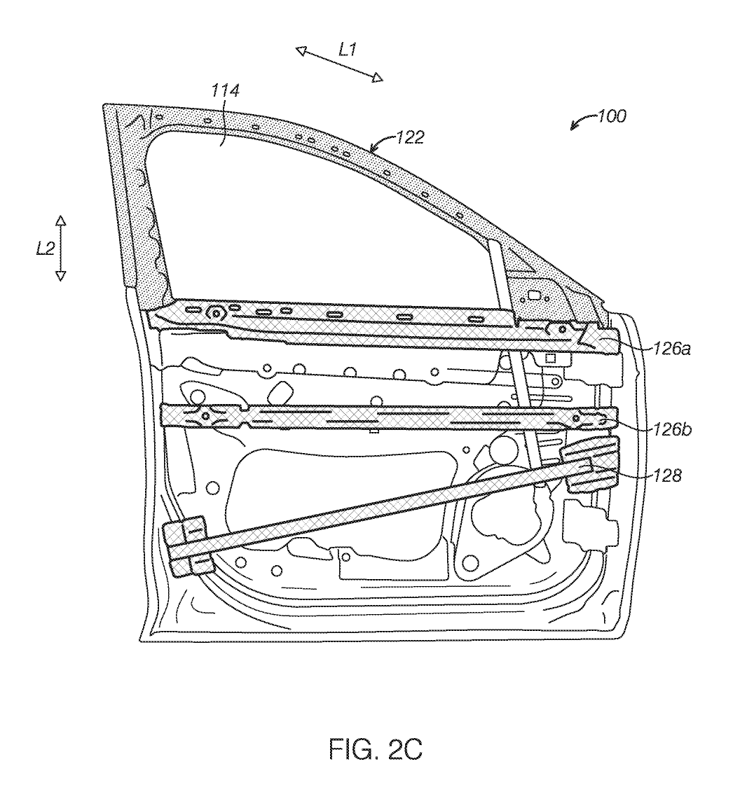

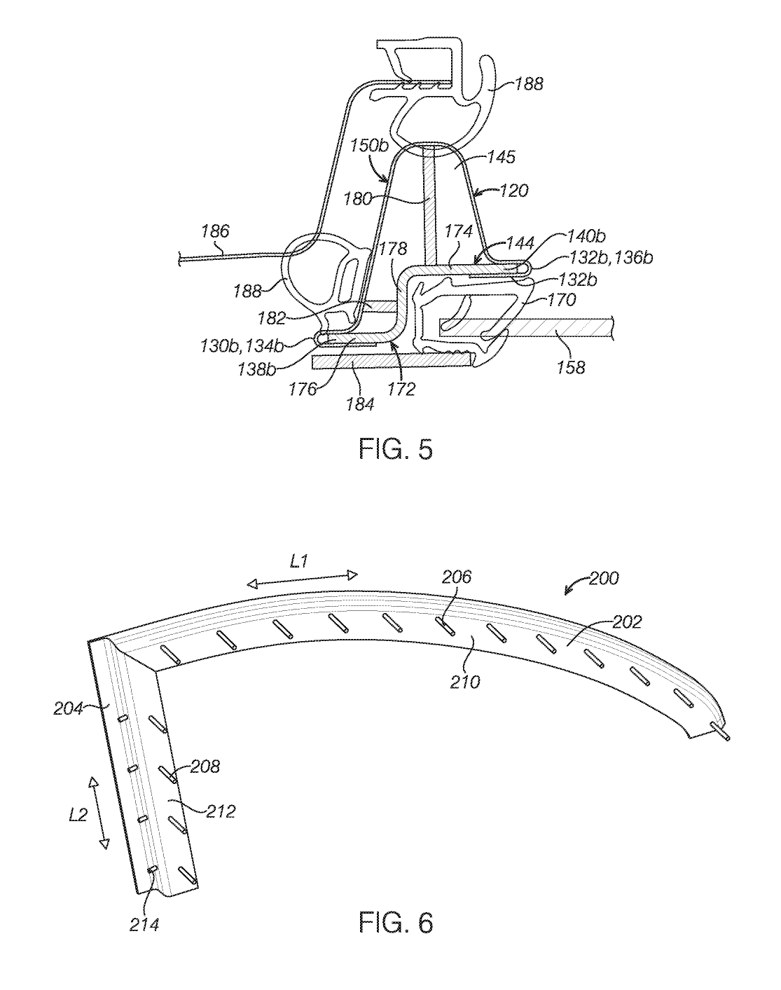

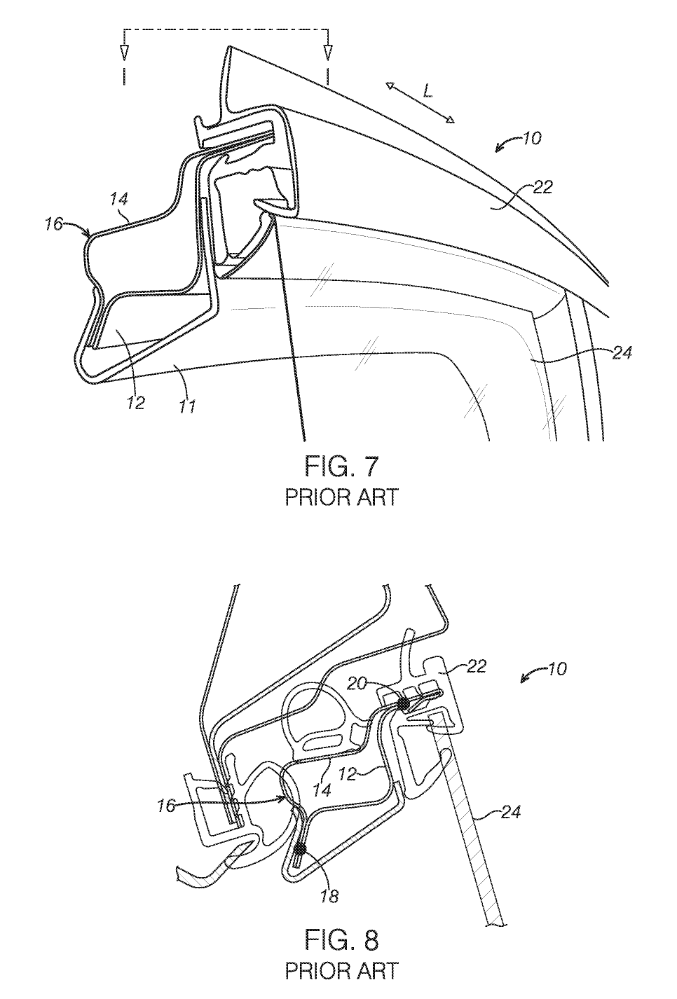

Referring to FIGS. 1-2C, FIG. 1 is a perspective view of a side door 100 of a vehicle according to one embodiment of the present disclosure, and FIGS. 2A-2C illustrates some stages of a door assembling process of the door in FIG. 1. The door 100 typically comprises an inner panel assembly 101 including an inner panel 102 and an outer panel 104. In some embodiments, the door assembling process may include three stages before the outer panel 104 is installed. In a first stage as shown in FIG. 2A, the inner panel 102 is provided and hinge reinforcements 106 and check arm reinforcements 108 are stalled on the inner panel 102. The inner panel 102 may be made from sheet metal such as steel or aluminum and formed in a stamping process. The inner panel 102 may include a main body 110 and an inner panel portion 112 and a window aperture 114 defined by a top edge 116 of the main body 110 and the inner panel portion 112. The inner panel portion 112 further includes a header inner panel portion 118 having a portion adjacent to a headliner of the vehicle and a pillar inner panel portion 120 adjacent to and along a pillar of the vehicle when the door 100 is closed. In one embodiment, the door 100 may be a front door and the pillar inner panel portion 120 may be adjacent to a B-pillar. The inner panel portion 112 may include a base 150 that is double bent and have an outer edge 130 and an inner edge 132 along a lengthwise direction L. The lengthwise direction as used herein elsewhere refers to a direction along a parameter of the window aperture 114. The outer edge 130 and the inner edge 132 are bent to form an outer clinched hem flange 134 and an inner clinched hem flange 136, respectively as described in detail below in FIGS. 4-5.

In a second stage as shown in FIG. 2B, a reinforcement part 122 and a glass channel 124 are connected to the inner panel portion 112 via a clinched hem process. The glass channel 124 may also be separate or co-molded steel insert or co-molded plastic piece into the reinforcement part 122. The reinforcement part 122 may be a one-piece and include a first reinforcement part 142 corresponding to the header inner panel portion 118 and a second reinforcement part 144 corresponding to the pillar panel portion 120. In some embodiments, the reinforcement part 122 may include a bottom part 146 formed integrally with the first and second reinforcement parts 142, 144. It should be appreciated that the bottom part 146 may not be necessary in some embodiments. Any appropriate clinch herring systems may be used in the clinched hem process. For example, the reinforcement part 122 may be placed on the inner panel portion 112 and a punching die may apply a force on the inner panel portion 112 such that the outer edge 130 and the inner edge 132 of the inner panel portion 112 are bent to form the outer clinched hem flange 134 and the inner clinched hem flange 136 to enclose an outer end 138 and an inner end 140 of the reinforcement part 122 along its lengthwise direction, respectively. That is, the outer end 138 and the inner end 140 of the reinforcement part 122 are received in the outer clinched hem flange 134 and the inner clinched hem flange 136 after the clinched hem process, and thus the reinforcement part 122 is jointed with the inner panel portion 112. The “edge” and the “end” as referred herein elsewhere include a portion adjacent to the edge or the end.

Use of the clinched hem process to connect both ends of the reinforcement part completely eliminates the welding of the reinforcement part with the inner panel which is conventionally used in assembling the reinforcement part with the inner panel. Without the need to be welded with the inner panel portion 112 of the door 100, the reinforcement part 122 may be made from any suitable material. In some embodiments, the reinforcement part may 122 be made from plastic or polymer. In one example, the reinforcement part 122 may be made from Nylon 6/6, or polymer including glass or carbon filled derivatives. With plastic or polymer material, the reinforcement part 122 may be formed in an injection molding,

In a third stage as shown in FIG. 2C, reinforcements 126a, 126b behind the outer panel 104 and a side crash reinforcement 128 are added. After the third stage, the outer panel 104 is assembled to the inner panel assembly 101.

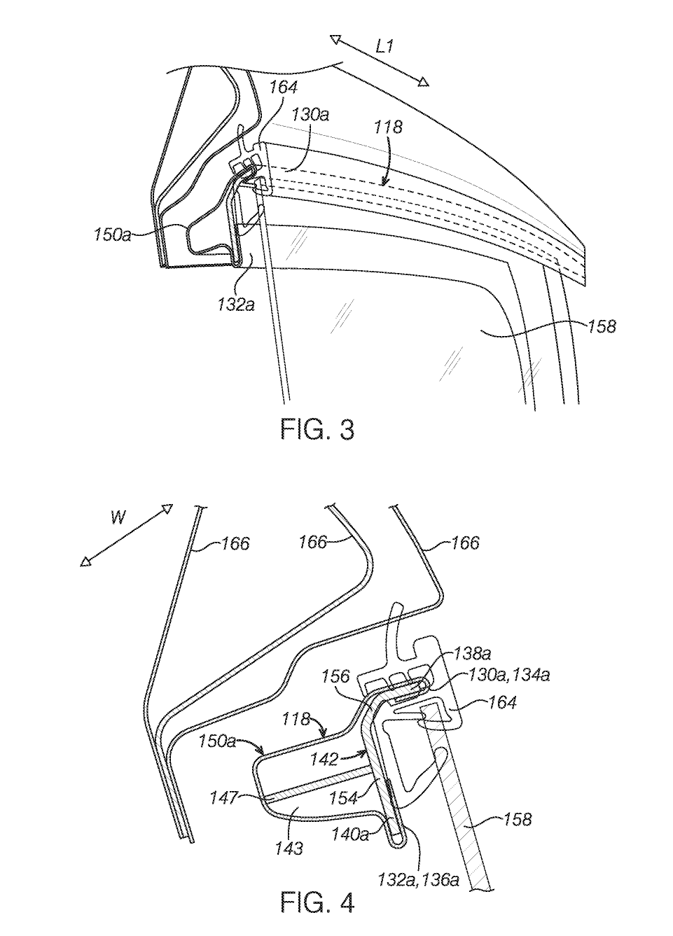

Referring to FIGS. 3-4 and with further reference to FIG. 1, connection between the header inner panel portion 118 and the first reinforcement part 142 is illustrated. FIG. 3 shows a partial perspective view of the door 100. FIG. 4 shows a cross-sectional view along lines 1141 in FIG. 1. The header inner panel portion 118 may include a first base 150a between a first outer edge 130a and a first inner edge 132a. The first base 150a may double bend such that the first outer edge 130a opposes the first inner edge 132a. The first outer edge 130a and the first inner edge 132a of the first base 150a are clinched on a first outer end 138a and a first inner end 140a of the first reinforcement part 142, respectively, to form the first outer clinched hem flange 134a and the first inner clinched hem flange 136a. The header inner panel portion 118 and the first reinforcement part 142 may form a first closed loop 143 at the cross section. In the depicted embodiment, the first base 150a may include a U-shaped portion at the cross section. The first outer clinched hem flange 134a is located closer to a top of the door and extends over the first inner clinched hem flange 136a in a direction W toward the glass pane 158. In other words, the first outer clinched hem flange 134a is closer to the glass pane 158 than the first inner clinched hem flange 136a in the widthwise direction W. Further, an opening of the first outer clinched hem flange 134a may face an interior of the first closed loop 143 or a direction away from the glass pane 158, and an opening of the first inner clinched hem flange 136a may face the first outer clinched hem flange 134a or a top of the vehicle door.

In some embodiments, the first reinforcement part 142 may have a flat portion 154 and a curved portion 156. The flat portion 154 may be substantially parallel a glass pane 158 and include the first inner end 140a received in the first inner clinched hem flange 136a, and the curved portion 156 may include the first outer end 138a received in the outer clinched hem. flange 134a As shown in FIG. 4, the first outer clinched hem flange 134a is disposed at a top of the window aperture 114 and connected with a glass run weather strip 164, and the first inner clinched hem flange 136a is disposed below the first outer clinched hem flange 132a and spaced further away from the glass pane 158. The header inner panel portion 118 and the first reinforcement part 142 form a boxed structure to provide the stiffness and strength to support the glass pane 158 and operation of the window.

In some embodiments, a garnish 11 used in the door 10 in prior art as shown in FIGS. 1-2 can be eliminated in the doors of the present disclosure. A glass run weather strip 164 may be hooked on the header inner panel portion 118 and the first reinforcement part 142 to conceal these parts from the view of the customers as shown in FIG. 4. As the glass run weather strip 164 forms the finished surface above the glass pane as shown in FIGS. 3 and 4, it can function as an applique at the upper portion of the door. In some embodiments, a chrome strip may be attached on an outer surface of the glass run weather strip 64 to have an appealing appearance.

It should be appreciated that the first reinforcement part 142 may have any suitable shape to he connected with the header inner panel portion 118 along a length direction L1 of the header inner panel portion 118 via a clinched hem process as long as both ends of the first reinforcement part 142 can be connected with the header inner panel portion via the clinched hem process and provide required strength to reinforce the window aperture 114 and the glass pane 158.

The first reinforcement part 142 may be made from plastic or polymer and formed in an injection molding. In some embodiments, a plurality of ribs 147 may he integrally formed with the first reinforcement part 142 in the injection molding. The ribs 147 may extend from a surface of the first reinforcement part 142 and a free end of the rib 147 may contact the header inner panel portion 118 to provide additional reinforcement. Alternatively, the free end of the rib 147 may not contact the header inner panel 118 and the rib 147 is configured to reinforce the body of the reinforcement part 142. With the extra strength provided by the rib 147, it is more flexible to design the shape of the first reinforcement part 142 and further reduce the weight of the first reinforcement part 142. Additionally, filler material may be disposed in the first closed loop 143 (not shown) to add more strength to the header inner panel portion 118. The filler material may be expandable foams or structural foams. One example is Terocore®. In one application, the unexpanded foam may be included on the reinforcement part 122. Once the car reached a paint shop, it will expand and fill the cavity between the inner panel and the reinforcement part, which would increase the stiffness as it would resist the collapse of the section.

FIG. 4 further shows a vehicle body 166. The glass run weather strip 164 is adjacent to the vehicle body 166. In some embodiments, the glass run weather strip 164 may be clipped onto an edge of the clinched hem flange. A plurality of tabs may be disposed along a direction L (e.g., L1 and/or L2) and the glass run weather strip 164 may be clipped to the small tabs.

In some embodiments, the first reinforcement part 142 connected with the header inner panel portion 118 may have a different configuration from the second reinforcement part 144 connected with the pillar inner portion 120. For example, the pillar inner panel portion 120 may require greater reinforcement than the header inner panel portion 118. The pillar inner panel portion 120 and the second reinforcement part 144 may be configured to meet the specific structural requirement. Referring to FIG. 5, a cross sectional view of the side door 100 in FIG. 1 along line III-III is shown to illustrate the structure of the pillar inner panel portion 120 and the second reinforcement part 144. The pillar inner panel portion 120 includes a second base 150b, a second outer edge 130b and a second inner edge 132b. The second outer edge 130b and the second inner edge 132b of the second base 150 are clinch teemed on a second outer end 138b and a second inner end 140b of the second reinforcement part 144, respectively, to form the second outer clinched here flange 1341 and the second inner clinched hem flange 136b. The pillar inner panel portion 120 and the second reinforcement part 144 may form a second closed loop 145 at the cross section. In the depicted embodiment, the second base 150b may include a U-shaped portion at the cross section. The boxed cross section of the inner panel portion 120 and the second reinforcement part 144 provide the stiffness. In some embodiments, the second outer clinched hem flange 134b may be located closer to a side edge of the door than the second inner clinched hem flange 136b. An opening of the second outer clinched hem flange 134b that receives the second outer end 138b may faces and offset an opening of the second inner clinched hem flange 136b that receives the second inner end 140b. The second inner clinched hem flange 136b may be adjacent to the window aperture 114 or the glass pane 158 and connected with a glass weather strip 170. The second outer clinched hem flange 134b may be disposed further away from the window aperture 114 or the glass pane 158.

In some embodiments, the second reinforcement part 144 may include a first portion 172 including the second outer end 138b received in the second outer clinched hem flange 134b and a second portion 174 including the second inner end 140b received in the second inner clinched hem flange 136b. The first portion 172 and the second portion 174 may have any suitable configuration to meet the structural requirement and adapt the geometry of the door. In one embodiments, the first portion 172 may further include a first segment 176 and a second segment 178 connected to the second portion 174. In the depicted embodiment in FIG. 5, the first segment 176 is substantially parallel to the glass pane 158 and the second portion 174, and the second segment 178 is disposed between the first segment 176 and the second portion 174 and have an angle with the first segment 176 and the second portion 174, respectively. In one example, the second segment 178 may be substantially perpendicular to the first segment 176 and the second portion 174. The pillar inner panel portion 120 and the second reinforcement part 144 forms the boxed section to provide the required strength for the window.

It should be appreciated that the second reinforcement part 144 may have any suitable shape to be connected with the pillar inner panel portion 120 along a length direction L2 of the pillar inner panel portion 120 via a clinched hem process as long as the second reinforcement part 144 can be connected with the pillar inner panel portion and provide required strength to reinforce the window aperture 114 and the glass pane 158.

The second reinforcement part 144 may be made from plastic or polymer and formed in an injection molding. In some embodiments, a plurality of ribs 180, 182 may be integrally formed with the second reinforcement part 144 in the injection molding. The ribs 180, 182 may extend from a surface of the second reinforcement part 144 and a free end of the rib 180, 182 may contact the pillar inner panel portion 120 to provide additional reinforcement. Alternatively, a free end of the rib 180, 182 may not contact the pillar inner panel portion 120 to provide additional reinforcement. With the extra strength provided by the rib 180, 182, it is more flexible to design the shape of the second reinforcement part 144 and further reduce the weight of the second reinforcement part 144. Additionally, filler material may be disposed in the second closed loop to add more strength to the pillar inner panel portion 120.

The first and second reinforcement parts 142, 144 may be integrally formed in an injection molding as a single one-piece. The different shapes of the first and second reinforcement parts 142, 144 are realized in the injection molding by the design of tooling.

In some embodiments, an applique 184 may be connected to the pillar inner panel portion 120 and the glass run weather strip 170 to conceal the pillar inner panel portion 120, a main body of the glass run weather strip 170 and the second reinforcement part 144 from the view of the customers. As the pillar inner panel portion 120 and the first reinforcement part 144 provide sufficient strength, the applique 184 is no longer a structural element but a decoration element. Thus, the thickness and the material cost of the applique 184 can be reduced due to more choices on the material and design. For example, the applique 184 may be made from glass and the glass applique gives a premium appearance on the door.

FIG. 5 further shows a vehicle body 186 and seals 188 adjacent to the pillar inner panel portion. 120. The glass run weather strip 170 is adjacent to the window aperture 114. In some embodiments, the glass run weather strip 170 may be connected to the pillar inner panel portion 120 and/or the second reinforcement part 144.

FIG. 6 shows a reinforcement part 200 according to one embodiment of the present disclosure. The reinforcement part 200 may include a first reinforcement part 202 and a second reinforcement part 204, which are integrally formed as a single piece in an injection molding process. In some embodiments, the reinforcement part 200 may further include a plurality of first ribs 206 disposed on the first reinforcement part 202 and a plurality of second ribs 208 disposed on the second reinforcement part 204, respectively. The first ribs 206 protrude from an inner surface 210 of the first reinforcement part 202 and the second ribs 208 protrude from an inner surface 212 of the second reinforcement part 204. The inner surfaces 210, 212 face the inner panel portion at an assembled position. In some embodiments, the first ribs 206 may be disposed evenly along a lengthwise direction L1 of the first reinforcement part 202 and the second ribs 208 may be disposed evenly along a lengthwise direction L2 of the second reinforcement part 204. In other embodiments, the first ribs 206 and the second ribs 208 may be disposed in selected areas along the direction L1 of the first reinforcement part 202 and the direction L2 of the second reinforcement part 204, respectively. The selected areas may be the areas that need extra strengthening. The first ribs 206 may have different shape and dimension from those of the second ribs 208 to adapt the geometry of the reinforcement part 200 and the inner panel portion, and meet the strength requirement. In some embodiments, a plurality of third ribs 214 may be formed on an inner surface of the second reinforcement part 204 to further enhance the strength of the reinforcement part 200. A tooling of an injection molding may be designed to generate the reinforcement part 200. It should he appreciated that the ribs are illustrated as examples and other embodiments are possible. For example, ribs may run a length of the first reinforcement part 202 and/or the second reinforcement part 204 to further provide structural stiffness.

The reinforcement part of the inner panel assembly of the present disclosure is connected to the inner panel portion via clinched hem process. As no welding is needed, the material of the reinforcement part is not limited to metallic material. For example, the reinforcement material may be made from the plastic or polymer. The plastic reinforcement part made from an injection molding can increase the material utilization. For example, material utilization for the plastic reinforcement part is 90% while the material utilization for a steel reinforcement part is 50%. Further, the reinforcement part of the present disclosure can result in an overall cost saving and weight reduction on the vehicle door. For example, the structure of the reinforcement part can result in the reduction of the material use for the applique, decrease of the overall width of the applique, reduction of the glass seal size and the door inner size.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombination of the various elements, features, functions and/or properties disclosed above and inherent to those skilled in the art pertaining to such inventions.

The following claims particularly point out certain combinations and subcombinations regarded as novel and nonobvious. These claims may refer to “an” element or “a first” element or the equivalent thereof Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application.

The invention claimed is:

1. An inner panel assembly of a side door of a vehicle, comprising:
an inner panel including an inner panel portion, wherein the inner panel portion includes a base, an outer edge and an inner edge along a length direction and partially defines a window aperture; and
a reinforcement part disposed between the outer edge and the inner edge of the inner panel portion and having a first end and a second end along the length direction, wherein the reinforcement part is connected to the inner panel portion via a clinch herring process and the first end and the second end of the reinforcement part are received in an outer clinched hem flange and an inner clinched hem flange of the inner panel portion formed by the outer edge and the inner edge during the clinch hem process, respectively.

2. The inner panel assembly of claim 1, wherein the reinforcement part is made from plastic, polymer, or recycled polymer and Wherein the inner panel portion is double bent and the inner panel portion and the reinforcement part form a closed loop at a cross section to provide required strength to support a glass pane in the window aperture.

3. The inner panel assembly of claim 2, wherein the inner panel portion includes a header inner panel portion and a pillar inner panel portion, and the reinforcement part includes a first reinforcement part corresponding to the header inner panel portion and a second reinforcement part corresponding to the pillar panel portion, wherein the first reinforcement part has a different configuration from the second reinforcement part, and the first and second reinforcement parts integrally formed in an injection molding.

4. A vehicle door, comprising:
an inner panel including an inner panel portion, wherein the inner panel portion partially surrounds a window aperture, and includes an outer clinched hem flange along a length direction and an inner clinched hem flange opposing the outer clinched hem flange; and
a reinforcement part disposed between the outer clinched hem flange and the inner clinched hem flange along the length direction, wherein an outer end of the reinforcement part is received in the outer clinched hem flange and an inner end of the reinforcement part is received in the inner clinched hem flange.

5. The vehicle door of claim 4, wherein the reinforcement part is made of polymer including glass or carbon filled derivatives.

6. The vehicle door of claim 4, wherein the reinforcement part is connected with the inner panel portion via a clinched herring process, and wherein a cross-section of the inner panel portion includes a 1-shape portion and forms a closed loop with the reinforcement part.

7. The door of claim 4, wherein the inner panel portion is made of steel or aluminum.

8. The vehicle door of claim 4, wherein the reinforcement part includes a plurality of ribs protruding toward an interior of the closed loop and contacting the inner panel portion.

9. The vehicle door for a vehicle of claim 8, wherein the reinforcement part and the ribs are integrally formed in an injection molding.

10. The vehicle door of claim 4, further comprising a filler material between the inner panel and the reinforcement part.

11. A vehicle door, comprising:
an inner panel including a header inner panel portion, a pillar inner panel portion, wherein the header inner panel portion and the pillar inner panel portion include an outer clinched hem flange and an inner clinched hem flange along a length direction, respectively;
a window aperture partially defined by the header inner panel portion, and the pillar inner panel portion;
a glass run weather strip connected to the header inner panel portion and the pillar inner panel and configured to receive a glass pane; and
a reinforcement part having an inner end and an outer end along the length direction, wherein the inner end is connected to the inner clinched hent flange and the outer end is connected to the outer clinched hem flange via a clinched hem process.

12. The vehicle door of claim f i, wherein the reinforcement part is made from plastic or a polymer.

13. The vehicle door of claim 12, wherein the header inner panel portion and the pillar inner panel portion include a base having a U-shaped cross section, respectively and wherein the header inner panel portion and the reinforcement part form a first closed loop at the cross section and the pillar inner panel portion and the reinforcement part form a second closed loop at the cross section, and wherein the outer clinched hem flange is formed by clinched heming an outer edge of the header inner panel portion to the outer end of the reinforcement part and the inner clinch hem flange is formed by clinch heming the inner end of the pillar inner panel portion to the second end of the reinforcement part.

14. The vehicle door of claim 13, wherein the reinforcement part includes a first reinforcement part connected with the header inner panel portion, wherein the first reinforcement part has a flat portion and a curved portion, wherein the flat portion is substantially parallel the Mass pane and includes the a first inner end received in a first inner clinched hem flange, and the curved portion includes a first outer end received in a first outer clinched hem flange, and wherein the first outer clinched hem flange is located at a top of the window aperture and connected with the glass run weather strip, and the first inner clinched hem flange located below the first outer clinched hem flange and spaced further away from the glass pane.

15. The vehicle door of claim 14, wherein the reinforcement part further includes a second reinforcement part connected with the pillar inner panel portion, wherein the second reinforcement part includes a first portion adjacent to the window aperture, a second portion further away from the window aperture, wherein the first portion includes a first outer end received in the outer clinched hem flange and the second portion includes a second inner end received in the inner clinched hem flange, wherein the inner clinched hem flange is adjacent to the window aperture and connected with glass run weather strip, and the outer clinched hem flange is disposed further away from the window aperture, and wherein the first and second reinforcement parts are integrally formed in an injection molding.

16. The vehicle door of claim wherein the first portion further includes a first segment and a second segment connected to the second portion, wherein the second segment is disposed between the first segment and the second portion and have an angle with first segment and the second portion, respectively.

17. The vehicle door of claim 12, wherein the reinforcement part includes a plurality of ribs protruding from a surface toward an interior of the closed loop and configured to contact the inner panel portion, and wherein the reinforcement part and the ribs are formed integrally in an injection molding.

18. The vehicle door of claim 17, wherein the plurality of ribs are disposed even along a length of the reinforcement part.

19. The vehicle door of claim 17, wherein the plurality of ribs are disposed in selected areas along a length of the reinforcement part.
